(19) United States
(12) Patent Application Publication
(10) Pub. No.: US 2023/0008648 A1
(43) Pub. Date: Jan. 12, 2023

(54) DISPLAY CONTROL DEVICE AND HEAD-UP DISPLAY DEVICE

(71) Applicant: NIPPON SEIKI CO., LTD., Niigata (JP)

(72) Inventor: Makoto HADA, Niigata (JP)

(21) Appl. No.: 17/783,403

(22) PCT Filed: Dec. 18, 2020
(86) PCT No.: PCT/JP2020/047470

§ 371 Date: Jun. 8, 2022

(30) Foreign Application Priority Data
Dec. 25, 2019 (JP) 2019-235289

(51) Int. Cl. G02B 27/01; G06T 3/00; B60W 40/105

(52) U.S. Cl. CPC G02B 27/0101; G06T 3/0093; B60W 40/105; G02B 2027/014

(57) ABSTRACT

In the case in which a loss of the viewpoint position of a driver occurs when a viewpoint position follow-up warping control is executed to update warping parameters according to the viewpoint position of the driver, and then the viewpoint position is re-detected, it is suppressed that the appearance of an image instantaneously changes in accordance with the update of the warping parameters and the driver is caused to feel uneasy. When the viewpoint loss in which at least one position of the right and left viewpoints becomes unclear is detected, a control unit, which executes the viewpoint position follow-up warping control, maintains, in a viewpoint loss period, the warping parameters set immediately before the viewpoint loss period, and, when the viewpoint position is re-detected after the viewpoint loss period, invalidates at least one warping process using the warping parameters corresponding to the re-detected viewpoint position.

### TECHNICAL FIELD

The present invention relates to a head-up display (HUD) device that projects the display light of an image onto a projected member such as a windshield or combiner of a vehicle and displays a virtual image in front of a driver, a display control device, and the like.

### BACKGROUND ART

In HUD devices, an image correction processing (hereinafter referred to as warping processing) is known in which an image to be projected is pre-distorted so as to have a characteristic opposite to the distortion of a virtual image caused by a curved surface shape or the like of an optical system, a windshield, or the like. The warping processing in HUD devices is described, for example, in Patent Document 1.

In addition, performing warping processing based on the driver's viewpoint position (viewpoint follow-up warping) is described, for example, in Patent Document 2.

### PRIOR ART DOCUMENT

### Patent Document

Patent Document 1: Japanese Unexamined Patent Application Publication No. 2015-87619

Patent Document 2: Japanese Unexamined Patent Application Publication No. 2014-199385

### SUMMARY OF THE INVENTION

### Problems to be Solved by the Invention

The present inventor examined the implementation of a viewpoint position follow-up warping control which updates a warping parameter in accordance with the viewpoint position of a driver (which can be interpreted broadly, such as a pilot or crew member), and recognized the new issue described below.

After a driver's viewpoint position moves and a HUD device temporarily loses that viewpoint position, the viewpoint position may be re-detected and the warping parameter may be updated on the basis of the re-detected viewpoint position.

Here, ideally, the image (virtual image) displayed after the warping processing should be a flat virtual image after the distortion caused by the optical system or the like is completely corrected. In the viewpoint position follow-up warping, it is ideal that a virtual image without distortion is always obtained even when the position of the viewpoint of a driver (user) changes, but the distortion cannot be completely removed.

Therefore, after the viewpoint position loss (lost) occurs, if simple viewpoint position follow-up warping is performed on the basis of the re-detected viewpoint position, even when a virtual image of the same image is displayed, the appearance of the virtual image seen by the driver (the state of the virtual image, the impression received from the virtual image, etc.) may change instantaneously, causing a sense of discomfort to the driver.

Further, as a mode of the viewpoint lost, it can be typically assumed that the viewpoint moves out of the eye box for some reason and then returns to the inside of the eye box, but it is not limited to this, and the viewpoint lost may occur when the driver's viewpoint moves instantaneously within the eye box. Even if saying the “viewpoint lost” in a word, there are many different modes. If necessary, it is also important to adopt measures that take into account the situation of the viewpoint lost.

Furthermore, in recent years, for example, a HUD device capable of displaying a virtual image over a fairly wide range in front of a vehicle has been developed, and such a HUD device tends to be large in size. Although the design of the optical system or the like has been devised to reduce distortion, it is difficult to achieve a uniform distortion reduction effect in, for example, all areas of the eye box. For instance, it is possible that a situation may occur in which when the driver's viewpoint is in the central area of the eye box, the degree of distortion can be significantly suppressed, but when the viewpoint is in the periphery of the eye box, the degree of residual distortion increases to some extent. This point may also be a factor that significantly changes the appearance of the virtual image by the warping processing after the loss of the viewpoint position.

An object of the present invention is to, in the HUD device, when performing the viewpoint position follow-up warping processing, suppress that the appearance of the image changes instantaneously with the update of the warping parameter, which causes a sense of discomfort to the driver, when the viewpoint position follow-up warping control that updates the warping parameter in accordance with the driver's viewpoint position is performed and the viewpoint position loss occurs, and then the viewpoint position is re-detected.

Other objects of the present invention will become apparent to those skilled in the art by referring to the aspects and the best embodiment exemplified below, and to the attached drawings.

### Solution to Problem

Aspects according to the present invention are exemplified below to allow the summary of the present invention to be easily understood.

In a first aspect, a display control device is a display control device that controls a head-up display (HUD) device which is mounted on a vehicle, which includes a display unit that displays an image and an optical system including an optical member that reflects and projects display light of the image onto the projected member, and which projects the image onto a projected member provided in the vehicle to thereby make a driver to visually recognize a virtual image of the image. The display control device includes a control unit that performs a viewpoint position follow-up warping control to update a warping parameter in accordance with a viewpoint position of the driver in an eye box and to pre-distort an image to be displayed on the display unit with use of the warping parameter in such a manner that the image has a characteristic opposite to a distortion characteristic of the virtual image of the image. When a viewpoint lost in which a position of at least one of right and left viewpoints of the driver is unclear is detected, the control unit maintains, in a viewpoint lost period, the warping parameter set immediately before the viewpoint lost period, and when a position of the viewpoint is re-detected after the viewpoint lost period, the control unit disables at least one warping processing that uses the warping parameter corresponding to the re-detected viewpoint position.

In the first aspect, during the viewpoint lost (sometimes referred to as a viewpoint loss or a viewpoint position loss) period, the warping parameter immediately before is maintained, and at the timing when the viewpoint position is re-detected, the warping by a new warping parameter is not performed immediately, but is performed with a delay.

In other words, when the viewpoint position is re-detected after the viewpoint lost, the control unit disables at least one warping processing that uses the warping parameter corresponding to the re-detected viewpoint position (setting the disabling period after re-detection), and then enables (performs) the warping processing that uses the warping parameter corresponding to the viewpoint position after the disabling period ends.

For example, it is assumed that the eye box is divided into multiple partial areas and a method for detecting the viewpoint position in units of each partial area is adopted. For example, it was found that the viewpoint was in “partial area A” immediately before the viewpoint lost, and the viewpoint lost occurred, and then the viewpoint moved to “partial area B” at the timing when the viewpoint position was re-detected. Even so, the warping processing to which the warping parameter corresponding to the position of the “partial area B” is applied is disabled (at least one disabling). When the viewpoint position moves from the partial area B to partial area C, the warping processing to which the warping parameter corresponding to the position of the partial area C can be disabled again (second disabling).

It is also possible to adaptively determine how many times to disable, taking into account the mode of the viewpoint lost (e.g., length of the viewpoint lost period), vehicle traveling state (e.g., vehicle speed), and the like.

In a second aspect dependent on the first aspect, the control unit compares the viewpoint lost time with a threshold value, and if the viewpoint lost time is shorter than the threshold value, the control unit may perform a control to lengthen a period during which the warping processing is disabled as compared to a case where the viewpoint lost time is longer than the threshold value.

In the second aspect, the control unit clocks a time during which the viewpoint position is lost (lost time or loss time), and if the lost time is shorter than a predetermined threshold value, the control unit performs a control to lengthen the period for disabling.

In the second aspect, by setting a longer period during which the warping parameter is fixed without changing and the visual quality of the image (virtual image) is maintained at a constant level, the driver can be made aware that the re-detection after the viewpoint lost has been successful and that the corresponding processing is now being performed. In other words, by extending the period during which the warping parameter is fixed and performing image processing using the warping parameter updated over time, even when the appearance of the image (virtual image) changes, the driver is made aware that the change does not occur suddenly with the movement of the driver's eyes and is a change with a margin in time.

This makes it easier for the driver to sense that, although the viewpoint position was lost due to the movement of one's own eyes, the system of the HUD device succeeded in re-detecting the viewpoint position, and the processing corresponding to the viewpoint lost has been performed.

In other words, the HUD device (system side) can present the driver who is the user that the processing after the viewpoint lost is being done properly. This gives the driver a sense of security and mental stability, and thus it is possible to obtain the effect of making a sense of discomfort less likely to occur or reducing a sense of discomfort.

In a third aspect dependent on the first aspect, the control unit compares the viewpoint lost time with a threshold value, and if the viewpoint lost time is shorter than the threshold value, the control unit may perform a control to shorten a period during which the warping processing is disabled as compared to a case where the viewpoint lost time is longer than the threshold value.

In the third aspect, the control unit clocks the viewpoint position lost time (loss time), and if the lost time is shorter than a predetermined threshold value, the control unit performs a control to shorten the period for disabling. The direction of control is opposite to the second aspect, and the second and third aspects have different effects to be obtained, and thus each aspect can be applied selectively in accordance with the expected effect.

When the viewpoint lost time is short, the change in the viewpoint position is considered to be small (the viewpoint movement distance is considered to be relatively short). Therefore, the time to disable the warping processing using a new warping parameter is set to be shorter than when the viewpoint lost time is longer. This allows, for example, after performing the minimum necessary disabling (timing delay), to reduce a sense of discomfort or suppress the occurrence of a sense of discomfort by quickly displaying an appropriate warping-corrected image (virtual image) corresponding to the viewpoint position.

In other words, when the viewpoint lost period is short, the movement distance of the viewpoint position is presumed to be small, and it can be assumed that there is little difference in the distortion of the virtual image before and after the updating of the warping parameter. Considering this point, a sudden change in the appearance of the virtual image immediately after the re-detection of the viewpoint position (in other words, in a fairly short time) is prevented, and then the normal viewpoint follow-up warping control is restored, thereby surely obtaining the effect of improving visibility.

In a fourth aspect dependent on any one of the first to third aspects, when an update cycle of the warping parameter before the viewpoint lost occurs and during the viewpoint lost period is defined as a first update cycle RT1 and an update cycle of the warping parameter during a period during which the warping processing is disabled is defined as a second update cycle RT2, the control unit may change a parameter update cycle in such a manner that RT1<RT2.

In the fourth aspect, a processing to lengthen the update cycle of the warping parameter (warping parameter update cycle change processing) is used in conjunction with a processing to maintain the parameter immediately before the viewpoint lost in the disabling period.

For example, if the frame rate of the image (virtual image) is 60 fps (frames per second), then image processing (image display processing) is performed at 60 frames per second (in other words, one frame period is 1/60 second). As an example, assume that it is normal to also update the warping parameter every frame.

Here, in the disabling period after the viewpoint lost, if the parameter is updated every 2 frames, the update cycle becomes 2/60 seconds, and if it is performed every 3 frames, the update cycle is 3/60 seconds, and the update cycle becomes longer. In this way, it is possible to lengthen (increase) the update cycle by switching to the update based on multiple frames. As the update cycle becomes longer, the reflection of the updated warping parameter in the image (virtual image) becomes slower. In other words, the sensitivity of reflecting the updated parameter in the display is slowed down. After the disabling period, the update cycle of the changed parameter will be restored (from RT2 to RT1). However, in reality, restoring the update cycle is not instantaneous, but requires a certain amount of time, and thus even if the parameter is switched, the reflection of the switched parameter in the actual display will be delayed.

This makes it easier to provide an appropriate delay of some time width (a delay that is long enough for the driver to perceive that the change in the appearance in the actual display has been delayed (in other words, a delay that effectively has the effect of slightly extending the width of the disabling period)). An effect such as facilitating the design of a timing control circuit can be expected.

Further, the degree of increase in the update cycle of the parameter can be controlled in a variable manner, or the timing of restoring the increased update cycle to its original cycle can be devised, thereby expanding the range of control variations and enabling flexible responses. The amount of delay in the actual display control can also be easily set quite widely.

In a fifth aspect dependent on the fourth aspect, after changing the parameter update cycle from the RT1 to the RT2, at an end timing of a period during which the warping processing is disabled, the control unit may restore the parameter update cycle from the RT2 to the RT1, or at a timing when a predetermined time has further elapsed from the end timing of the period during which the warping processing is disabled, the control unit may restore the parameter update cycle from the RT2 to the RT1, or the control unit may start changing the parameter update cycle starting from the end timing of the period during which the warping processing is disabled, and gradually restore the parameter update cycle from the RT2 to the RT1 with a lapse of time.

In the fifth aspect, examples of a mode in which the update cycle is restored after performing the processing of lengthening the update cycle in the fourth aspect.

In a first example, the long update cycle is synchronized with the switching (updating) of the warping parameter and is restored to the original short update cycle. Even in this case, a certain amount of time is needed to change the update cycle, and thus that much delay is ensured.

In a second example, the parameter update cycle is restored after a predetermined time has further elapsed from the time of switching (updating) the warping parameter. In this example, the timing of restoring the update cycle is delayed by a predetermined amount of time from the timing of switching (updating) the parameter, further delaying the reflection of the changed parameter in the display, which thus makes it easier to ensure the delay of an appropriate length that can be perceived by a human eye.

In a third example, when restoring the update cycle, it is restored gradually over a predetermined period. In other words, a control is performed in which when the parameter update cycle is restored from, for example, 1/15 second to 1/60 second, the cycle is not restored immediately, but is gradually switched to 1/30 second, 1/45 second, and 1/60 in a predetermined time as a unit. By controlling the gradual switching of the update cycle on the time axis, the delay in reflecting the changed parameter in the display can be managed with greater precision.

In a sixth aspect dependent on any one of the first to fifth aspects, a low-speed state determination unit that determines whether a speed of the vehicle is in a low-speed state may be further included, and the control unit may lengthen a period during which the warping processing is disabled when the vehicle is in the low-speed state including a stopped state, as compared to a period during which the warping processing is disabled in a state where the vehicle is in a state faster than the low-speed state.

In the sixth aspect, when the vehicle is in a low-speed state, the disabling period is set longer than when the vehicle is in a medium-speed or high-speed state (in other words, the timing for switching the warping parameter is further delayed). In a low-speed state, the driver is sensitive to visual fluctuations in the front and the like and can easily detect these fluctuations. Therefore, at this time, a measure is taken in such a manner that the reflection of the new parameter in the image after the viewpoint lost is delayed to a greater extent, and a sense of discomfort caused by the instantaneous change in display appearance is less likely to occur. As the vehicle speed increases out of the low-speed state, the disabling periods are reduced (it is possible to include a case where the disabling period is eliminated), and a control is performed with an emphasis on accelerating the distortion correction of the image based on the viewpoint position re-detected after the lost. This allows for an appropriate warping control in response to a vehicle speed.

In a seventh aspect dependent on any one of the first to sixth aspects, the control unit may change a period during which the warping processing is disabled in accordance with a vehicle speed of the vehicle, and in this case, when a speed of the vehicle is within a range of equal to or higher than a first speed value U1 (U1>0) and equal to or lower than a second speed value U2 that is higher than the first speed value, the control unit may perform a control to reduce the period during which the warping processing is disabled with respect to the vehicle speed as the vehicle speed becomes fast, or may perform a control to moderate a degree of the reduction when the vehicle speed is in a range close to the first speed value and to make the degree of the reduction steeper as the vehicle speed becomes away from the first speed value, or may perform a control to moderate the degree of the reduction when the vehicle speed is in a range close to the first speed value, to make the degree of the reduction further steeper as the vehicle speed becomes away from the first speed value, and to moderate the degree of the reduction as the vehicle speed approaches the second speed value.

In the seventh aspect, when performing a control to shorten (in other words, reduce) the period during which the warping processing is disabled as the vehicle speed increases, the control may be performed when the vehicle speed is within a range of equal to or higher than a first speed value U1 (U1>0) and equal to or lower than a second speed value U2 that is higher than the first speed value (first control). In this case, the control may not be performed in a range where the vehicle speed is below the first speed U1 and above the second speed U2, so as not to impose an excessive burden on the system of the HUD device. Further, by reducing the disabling period with respect to the speed, a more flexible and appropriate warping processing according to the speed is possible.

Further, when the vehicle is in a low-speed state where the driver can easily perceive visual changes in the image (virtual image) (in other words, the vehicle speed is in a range close to the first speed value U1), the control to moderate a degree of reduction in the disabling period in such a manner that a sudden warping parameter update is suppressed may be performed (second control). In this case, a more precise control can be achieved.

Further, in addition to the second control described above, a control to moderate the degree of reduction in the disabling period as the vehicle speed approaches the second speed value U2 (an control of the inverted S-shaped characteristic) may be further performed, and when the vehicle speed reaches the second speed value U2, the reduction is stopped and the disabling period becomes constant, thereby suppressing that the change suddenly (unexpectedly) peaks out and a sense of discomfort occurs (third control). This can further improve the visibility of a virtual image.

In an eighth aspect dependent on any one of the first to seventh aspects, when adjusting a position of the eye box in accordance with a height position of the viewpoint of the driver, the head-up display device may not move the optical member and may change a reflection position of display light of the image in the optical member.

In the eighth aspect, when the height position of the eye box EB is adjusted in accordance with the height position of the driver's eyes (viewpoint), the HUD device that performs the above control does not rotate the optical member which projects light onto the projected member by, for example, using an actuator, but changes the reflection position of the light in the optical member.

In recent years, HUD devices tend to be developed on the premise of displaying a virtual image over a fairly wide area in front of a vehicle, for example, and this inevitably makes the device larger. As a matter of course, the optical member will also become larger. If this optical member is rotated with the use of an actuator or the like, the precision of controlling the height position of the eye box may be degraded due to the error. To prevent this, the position at which a light ray is reflected by the optical member is changed.

In such a large optical member, the distortion of the virtual image is prevented as much as possible by optimally designing the reflection surface as a free curved surface. However, as mentioned above, distortions may inevitably become apparent when, for example, the driver's viewpoint is located in the periphery of the eye box. Therefore, in such a case, the above control to temporarily disable (delay) the application of the parameter corresponding to the viewpoint position after the re-detection within a predetermined range is performed, whereby it is possible to make a sense of discomfort due to a change in appearance caused by distortion of the virtual image less likely to occur, and to effectively utilize the above control to improve the visibility.

In a ninth aspect dependent on any one of the first to eighth aspects, a hypothetical virtual image display surface corresponding to an image display surface of the display unit may be arranged so as to be superimposed on a road surface in front of the vehicle, or may be arranged at an angle with respect to the road surface in such a manner that a distance between a near end portion that is an end portion of the virtual image display surface on a side closer to the vehicle and the road surface is small, and a distance between a far end portion that is an end portion of the virtual image display surface on a side further from the vehicle and the road surface is large.

In the ninth aspect, a hypothetical virtual image display surface (corresponding to a display surface such as a screen as a display unit) arranged in front of the vehicle or the like in a HUD device is provided so as to be superimposed on the road surface or inclined with respect to the road surface. The former is referred to as a road surface superimposition HUD, while the latter is sometimes referred to as an inclined surface HUD.

These can perform various displays with the use of the wide virtual image display surface superimposed on the road surface or the wide virtual image display surface provided at an angle with respect to the road surface in the range of, for example, 5 m to 100 m, in front of the vehicle. It is preferable that the HUD device is increased in size and the eye box is also increased in size to detect the viewpoint position with high accuracy in a wider range than before and perform image correction using an appropriate warping parameter. However, if the viewpoint lost occurs, the highly accurate control of switching the warping parameter may in fact reduce the visibility of the image (virtual image) after the viewpoint is re-detected. Therefore, the application of the control method of the present invention becomes effective.

Those skilled in the art will readily understand that the exemplified aspects according to the present invention may be further modified without departing from the spirit of the invention.

### BRIEF DESCRIPTION OF THE DRAWINGS

FIG. 1(A) is an overview of warping processing and is a diagram for explaining a distortion of a virtual image (and a virtual image display surface) displayed through the warping processing. FIG. 1(B) is a diagram illustrating an example of the virtual image visually recognized by a driver through a windshield.

FIG. 2(A) is a diagram for explaining an overview of a viewpoint position follow-up warping processing. FIG. 2(B) is a diagram illustrating a configuration example of the eye box with its interior divided into multiple partial areas.

FIGS. 3(A) to 3(F) are diagrams illustrating examples of virtual images with different distortions after the warping processing.

FIG. 4 is a diagram illustrating an example of a viewpoint lost in an eye box whose interior is divided into multiple partial areas and re-detection of a viewpoint position.

FIG. 5 is a diagram illustrating an example of a system configuration of a HUD device.

FIGS. 6(A) to 6(C) are timing charts illustrating an example of a control that provides a period during which the warping processing based on the re-detected viewpoint position is disabled.

FIGS. 7(A) to 7(D) are timing charts illustrating an other example of a control that provides a period during which the warping processing based on the re-detected viewpoint position is disabled (a case where parameter update cycle change processing is used together).

FIGS. 8(A) and 8(B) are timing charts illustrating an other example of a control that provides a period during which the warping processing based on the re-detected viewpoint position is disabled (first control example in a case where a viewpoint lost period is shorter than a threshold value).

FIGS. 9(A) and 9(B) are timing charts illustrating an other example of a control that provides a period during which the warping processing based on the re-detected viewpoint position is disabled (second control example in a case where a viewpoint lost period is shorter than a threshold value).

FIG. 10 is a diagram illustrating an example of a characteristic in a case where the period during which the warping processing based on the re-detected viewpoint position is disabled is controlled in a variable manner in accordance with a vehicle speed.

FIG. 11 is a flowchart illustrating an example of a procedure for a warping image correction control corresponding to a viewpoint lost (first control example).

FIG. 12 is a flowchart illustrating an example of a procedure for a warping image correction control corresponding to a viewpoint lost (second control example).

FIG. 13 is a flowchart illustrating an example of a procedure for a warping image correction control corresponding to a viewpoint lost (third control example).

FIG. 14(A) is a diagram illustrating a display example by a road surface superimposition HUD. FIG. 14(B) is a diagram illustrating a display example by an inclined surface HUD. FIG. 14(C) is a diagram illustrating a configuration example of a main part of a HUD device.

### MODE FOR CARRYING OUT THE INVENTION

The best embodiment described below is used so that the present invention is easily understood. Therefore, a person skilled in the art should note that the present invention is not unduly limited by the embodiments described below.

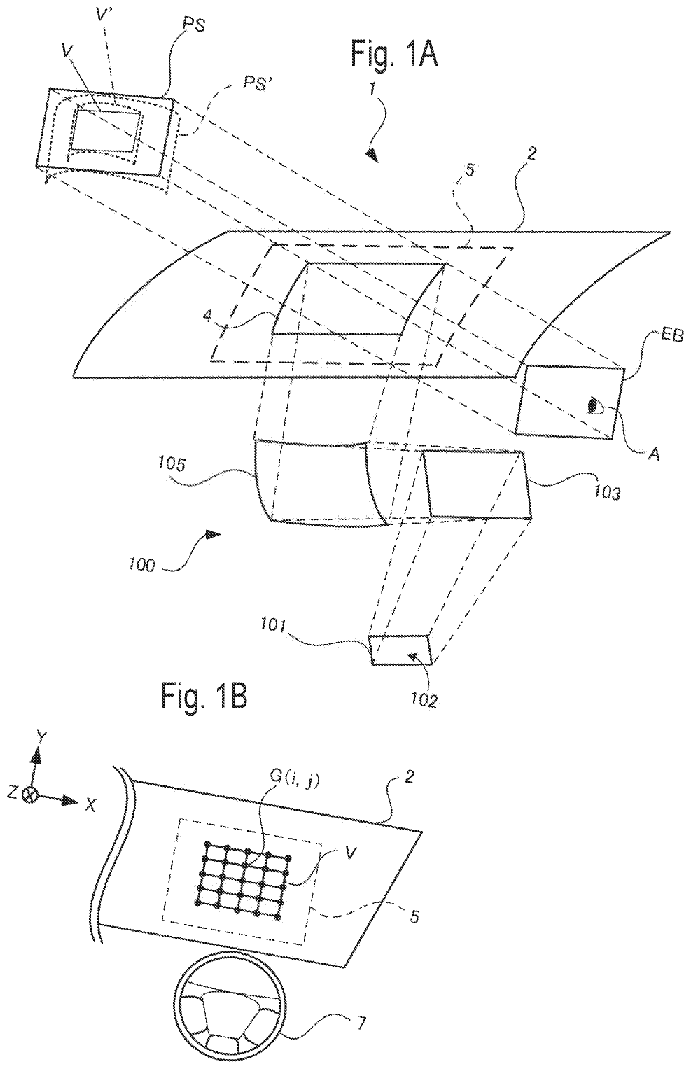

The following description refers to FIG. 1. FIG. 1(A) is an overview of warping processing and is a diagram for explaining a distortion of a virtual image (and a virtual image display surface) displayed through the warping processing. FIG. 1(B) is a diagram illustrating an example of the virtual image visually recognized by a driver through a windshield.

As illustrated in FIG. 1(A), a HUD device 100 includes a display unit (for example, a light-transmitting screen) 101, a reflecting mirror 103, a curved mirror (for example, a concave mirror, and the reflection surface may be a free curved surface) 105 as an optical member that projects display light. An image displayed on the display unit 101 is projected onto a virtual image display area 5 of a windshield 2 as a projected member via the reflecting mirror 103 and the curved mirror 105. In FIG. 1, a reference numeral 4 indicates a projection area. The HUD 100 may be provided with a plurality of curved mirrors, and in addition to the mirror (reflection optical element) of the present embodiment, or in place of a part (or all) of the mirror (reflection optical element) of the present embodiment, the HUD 100 may include a refraction optical element such as a lens and a functional optical element such as a diffractive optical element.

Part of the display light of the image is reflected by the windshield 2, is incident on a viewpoint (eye) A of a driver or the like located inside of (or on) a preset eye box EB (here, the eye box EB has a quadrangular shape having a predetermined area), and is formed in front of a vehicle 1, and thus a virtual image V is displayed on a hypothetical virtual image display surface PS corresponding to a display surface 102 of the display unit 101.

The image on the display unit 101 is distorted due to the shapes of the curved mirror 105 and the windshield 2. To offset that distortion, the image is subjected to a distortion of the opposite characteristic of that distortion. This pre-distortion (preposing distortion) method of image correction is referred to herein as warping processing or warping image correction processing.

Ideally, the virtual image V displayed on the virtual image display surface PS by the warping processing becomes an uncurved flat image. However, for example, it is undeniable that some distortion remains in a large HUD device 100 or the like that projects the display light onto the wide projection area 4 on the windshield 2 and sets the virtual image display distance in a fairly wide range, which is unavoidable.

In the upper left of FIG. 1, a dashed line PS′ indicates the virtual image display surface where the distortion has not been completely removed, and V′ indicates the virtual image displayed on the virtual image display surface PS′.

Further, the degree of distortion or the mode of distortion of the virtual image V in which the distortion remains depends on the position of the viewpoint A on the eye box EB. Since the optical system of the HUD device 100 is designed on the assumption that viewpoint A is located near the center, when the viewpoint A is near the center, the distortion of the virtual image is relatively small, and the distortion of the virtual image tends to increase as the viewpoint A approaches the periphery.

FIG. 1(B) illustrates an example of a virtual image V that is visually recognized by the driver through the windshield 2. In FIG. 1(B), the virtual image V having a rectangular outer shape has, for example, five vertically and five horizontally, for a total of 25 reference points (reference pixel points) G(i, j) (here, i and j are both variables that can take a value of 1 to 5). For each reference point in the image (original image), a distortion having the opposite characteristic to the distortion generated in the virtual image V is given by the warping processing. Therefore, ideally, the pre-applied distortion and the actual distortion are offset, and ideally, an uncurved virtual image V such as that illustrated in FIG. 1(B) is displayed. The number of reference points G(i, j) can be increased by interpolation or other processing. In FIG. 1(B), a reference numeral 7 is a steering wheel.

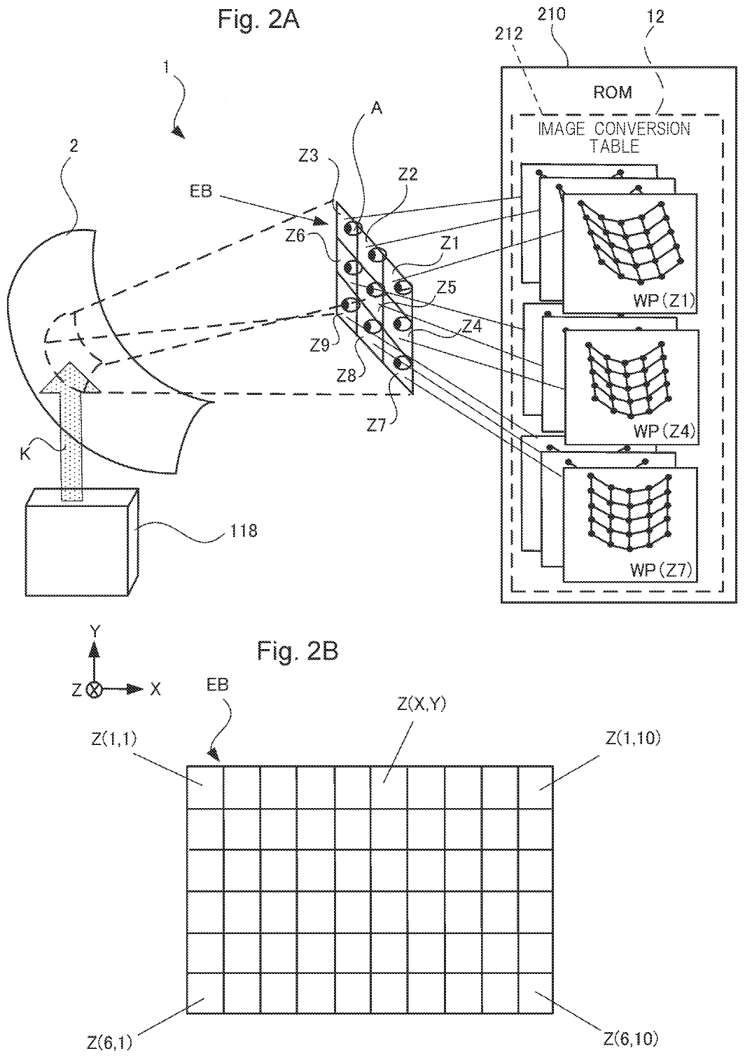

The description will be continued with reference to FIG. 2. FIG. 2(A) is a diagram for explaining an overview of a viewpoint position follow-up warping processing. FIG. 2(B) is a diagram illustrating a configuration example of the eye box with its interior divided into multiple partial areas. In FIG. 2, the same parts as those in FIG. 1 are assigned the same reference numerals (the same applies to the subsequent drawings).

As illustrated in FIG. 2(A), the eye box EB is divided into multiple (here, nine) partial areas Z1 to Z9, and the position of the driver's viewpoint A is detected in the unit of the respective partial areas Z1 to Z9.

Display light K of the image is emitted from a projection optical system 118 of the HUD device 100, and part of the display light K is reflected by the windshield 2 and incident on the driver's viewpoint (eye) A. When the viewpoint A is in the eye box, the driver can visually recognize the virtual image of the image.

The HUD device 100 includes a ROM 210, and the ROM 210 incorporates an image conversion table 212. The image conversion table 212 stores, for example, a warping parameter WP that determines a polynomial, a multiplier, a constant, or the like for image correction (warping image correction) by a digital filter. The warping parameter WP is provided for each of the partial areas Z1 to Z9 in the eye box EB. In FIG. 2(A), the warping parameters WP (Z1) to WP (Z9) corresponding to each partial area are illustrated. In the figure, only WP (Z1), WP (Z4), WP (Z7) are illustrated as reference numerals.

When the viewpoint A moves, the position of the viewpoint A among the multiple partial areas Z1 to Z9 is detected. Then, any one of the warping parameters WP (Z1) to WP (Z9) corresponding to the detected partial area is read from the ROM 210 (warping parameter update), and the warping processing is performed with the use of the warping parameter.

FIG. 2(B) illustrates an eye box EB with a larger number of partial areas than the example of FIG. 2(A). The eye box EB is divided into, six vertically and ten horizontally, for a total of 60 partial areas. Each partial area is labeled as Z(X, Y) with each coordinate position in the X and Y directions as a parameter.

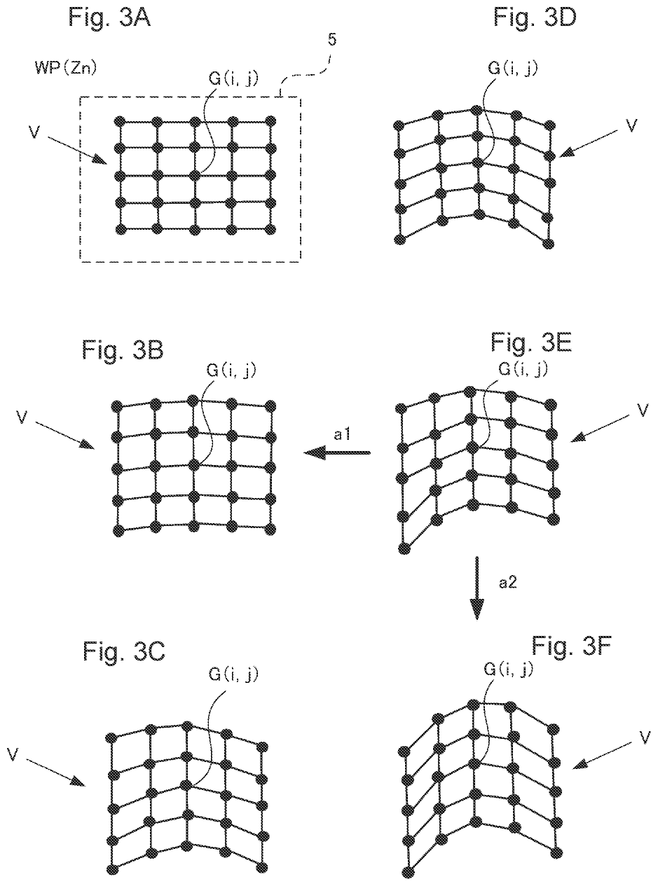

The description will be continued with reference to FIG. 3. FIGS. 3(A) to 3(F) are diagrams illustrating examples of virtual images with different distortions after the warping processing. As described above, the appearance of the virtual image V after the warping processing depends on where the driver's viewpoint A is located in the eye box.

As illustrated in FIG. 3(A), the virtual image V displayed in the virtual image display area 5 of the windshield 2 should ideally be undistorted and displayed in an uncurved manner. However, distortion remains in the actual virtual image V even after the warping processing is applied, and the degree and mode of the distortions vary depending on the position of the viewpoint A.

In the example of FIG. 3(B), there is distortion, but it is relatively mild distortion, and the virtual image V has the visual quality similar to that of FIG. 3(A). In the example of FIG. 3(C), the tendency of distortion is the same as in FIG. 3(B), but the degree of distortion is greater, and the visual quality is not the same as in FIG. 3(A).

In the example of FIG. 3(D), the degree of distortion is the same as in FIG. 3(C), but the mode of distortion (the tendency of distortion, or the mode in which the virtual image appears after distortion occurs) is different from that in FIG. 3(C).

In the example of FIG. 3(E), the degree of distortion is greater and the virtual image V is not balanced on the right and left sides. In the example of FIG. 3(F), the virtual image V tends to be distorted in a similar way to FIG. 3(E), but the appearance is quite different from FIG. 3(F).

Thus, even for a virtual image V displaying the same content (virtual image V after the warping processing), the appearance varies considerably depending on the position of viewpoint A. For example, when the viewpoint A is located in the center of the eye box, the visible virtual image V has relatively little distortion as illustrated in FIG. 3(B). However, when the viewpoint A moves from the center to the periphery, the distortion becomes relatively large, as illustrated in FIG. 3(E).

In this state (in the case of FIG. 3(E) in which the viewpoint A is located in one partial area in the periphery of the eye box), for example, assuming the case of that the viewpoint A moves to an other partial area and the appearance of the virtual image V changes (change a1) as illustrated in FIG. 3(B), for example, or the case that the appearance of the virtual image V changes (change a2) as illustrated in FIG. 3(F), in either case, the appearance changes considerably, increasing the possibility that the driver (user) will feel a sense of discomfort.

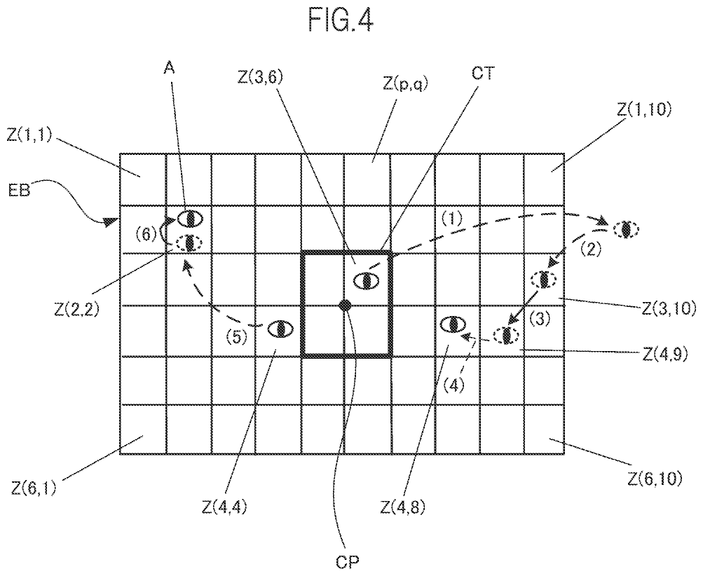

The description will be continued with reference to FIG. 4. FIG. 4 is a diagram illustrating an example of a viewpoint lost in an eye box whose interior is divided into multiple partial areas and re-detection of a viewpoint position. FIG. 4 illustrates an example of each of the viewpoint movements (1) to (6) as a manner in which the viewpoint position after the viewpoint lost has occurred is re-detected.

A typical example of the viewpoint lost is when, while driving, the driver's viewpoint A leaves the eye box EB and the detection of its position is interrupted, and then the viewpoint A returns to the eye box EB. FIG. 4 illustrates examples of (1) to (6) movement as a mode of viewpoint movement in this case. In viewpoint movement (1), the viewpoint A moves from inside a central area CT of the eye box EB to the outside of the eye box EB. The movement distance is long and the lost time of the viewpoint is large. In this case, even when the viewpoint A returns to the eye box EB, for example, it can be assumed that the viewpoint A moves through (2) and (3), and then stays at (4), which will be unstable (many fluctuations).

Further, the viewpoint lost may occur when the viewpoint A does not go out of the eye box EB but moves in multiple partial areas instantaneously, as in viewpoint movement examples (5) and (6). In the viewpoint movement examples (5) and (6), the movement distance is shorter, the lost time of the viewpoint is smaller, and the viewpoint movement is relatively stable compared to the movement manners (1) to (4) above. There are a variety of modes of the viewpoint lost, and a flexible response is desirable.

In the present embodiment, basically, a measure is taken in which, during the period when the viewpoint lost (viewpoint loss) occurs, the warping parameter immediately before is maintained, and the disabling period is started from the timing when the viewpoint A is re-detected, and in the disabling period, at least one warping processing that uses the warping parameter corresponding to the re-detected viewpoint position is disabled. In the disabling period, the warping parameter immediately before the viewpoint lost is maintained.

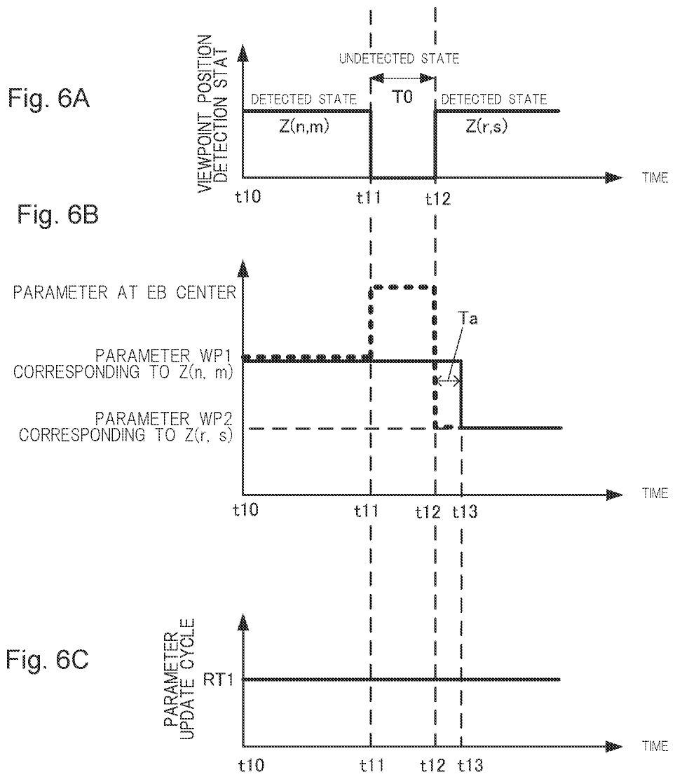

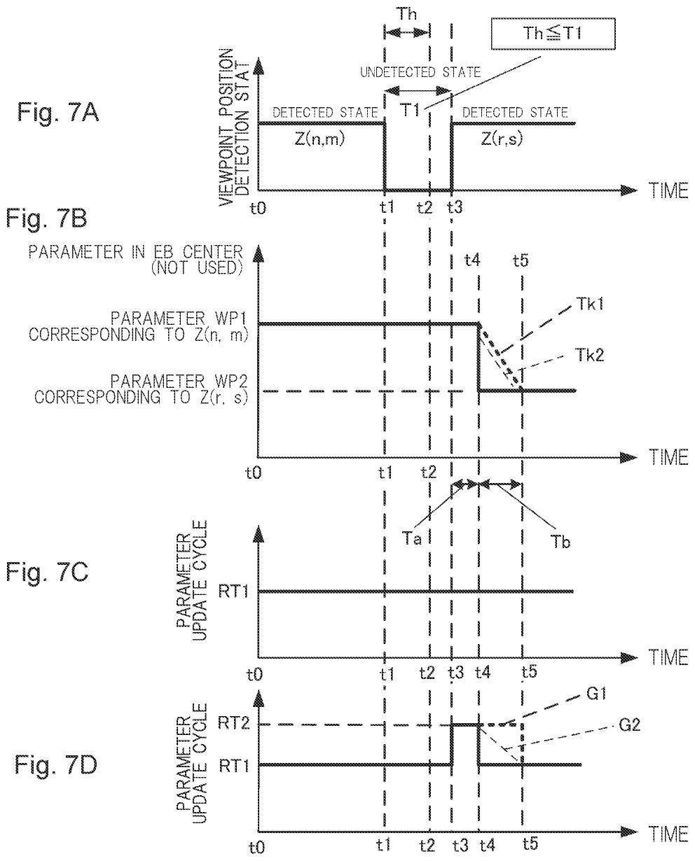

It can be assumed that a warping parameter corresponding to the position of a center (reference sign CP) of the eye box EB is adopted during the viewpoint lost period. However, in this case, the parameter is subjected to stepwise processing of shifting from the parameter immediately before the viewpoint lost to the parameter corresponding to the center CP once, and then to the parameter corresponding to the position after re-detection. Since there is a high possibility that the appearance of the virtual image will change due to the switching of the warping parameter, the warping parameter corresponding to the center CP is not adopted in the present embodiment. As described above, during the viewpoint lost period and the subsequent disabling period, the warping parameter immediately before viewpoint lost is maintained, thereby performing the control to suppress changes in the appearance of the virtual image. By setting the disabling period to an appropriate length, for example, only the warping associated with the re-detection of the viewpoint A immediately after the viewpoint movement (2) in FIG. 4 can be disabled, or the warping associated with the re-detection of the viewpoint A immediately after the viewpoint movement (3) can further be disabled as well (for instance, examples of FIGS. 6 and 7).

Further, in the disabling period, the warping parameter update cycle change processing (processing to lengthen the update cycle) can be used in combination. Further, in doing so, the application processing of continuing the period of increasing the parameter update cycle for some time after the disabling period ends can be performed, and the application processing of gradually restoring the update cycle to its original cycle over time can also be used in combination (examples of FIGS. 7(A) to 7(D)).

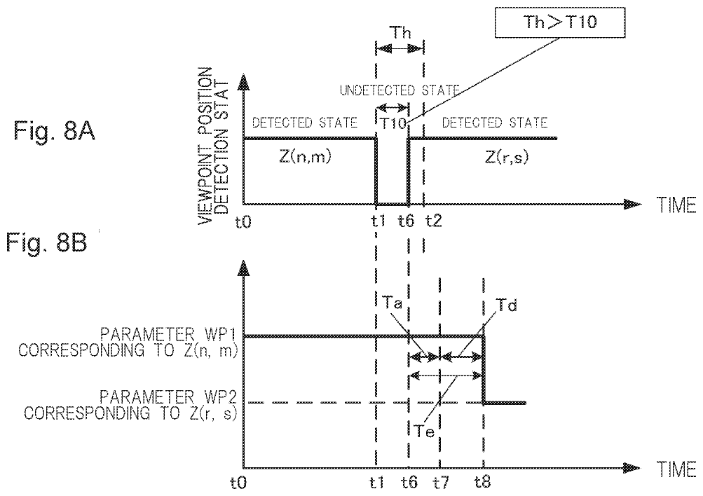

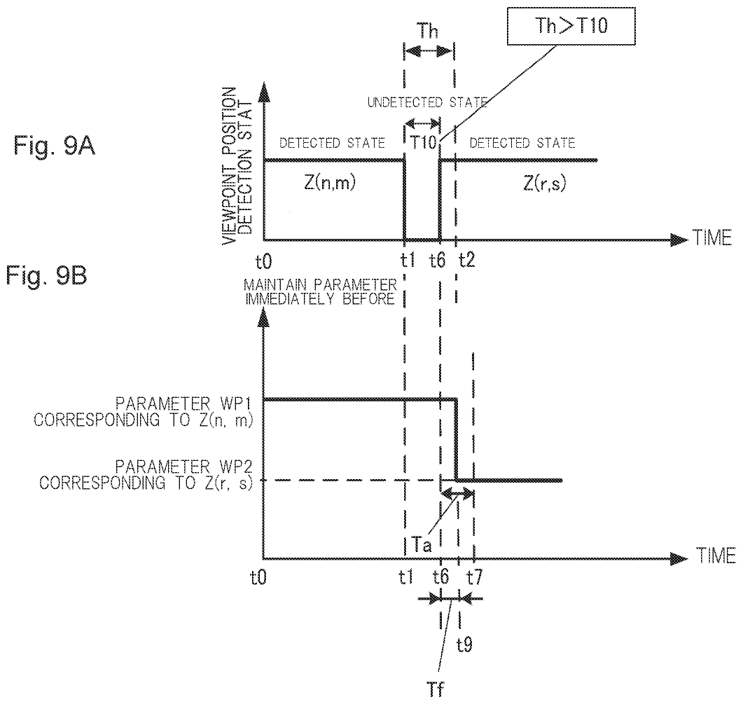

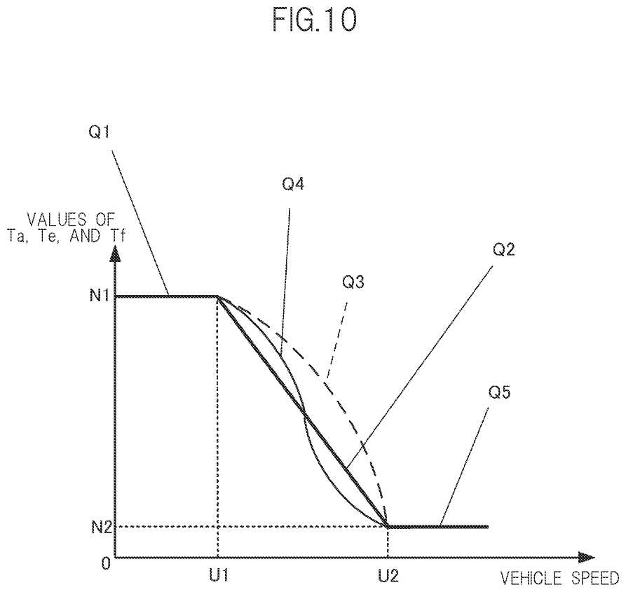

Further, the disabling period may be controlled in a variable manner, corresponding to whether the viewpoint lost period is longer or shorter than a threshold value (threshold value for comparison/determination). For example, the driver (user) can be reassured that the viewpoint has been re-detected after the viewpoint lost (a lost of relatively short viewpoint movement) caused by the viewpoint movement (5) in FIG. 4 (example of FIG. 8), or on the other hand, it is possible to terminate the disabling relatively early and quickly perform the warping processing using a parameter corresponding to the viewpoint position after the movement, thereby suppressing the redundant disabling period (example of FIG. 9). Further, an adaptive control based on a vehicle speed may also be performed by varying the disabling period in accordance with the vehicle speed (example of FIG. 10). The details of these contents will be discussed below.

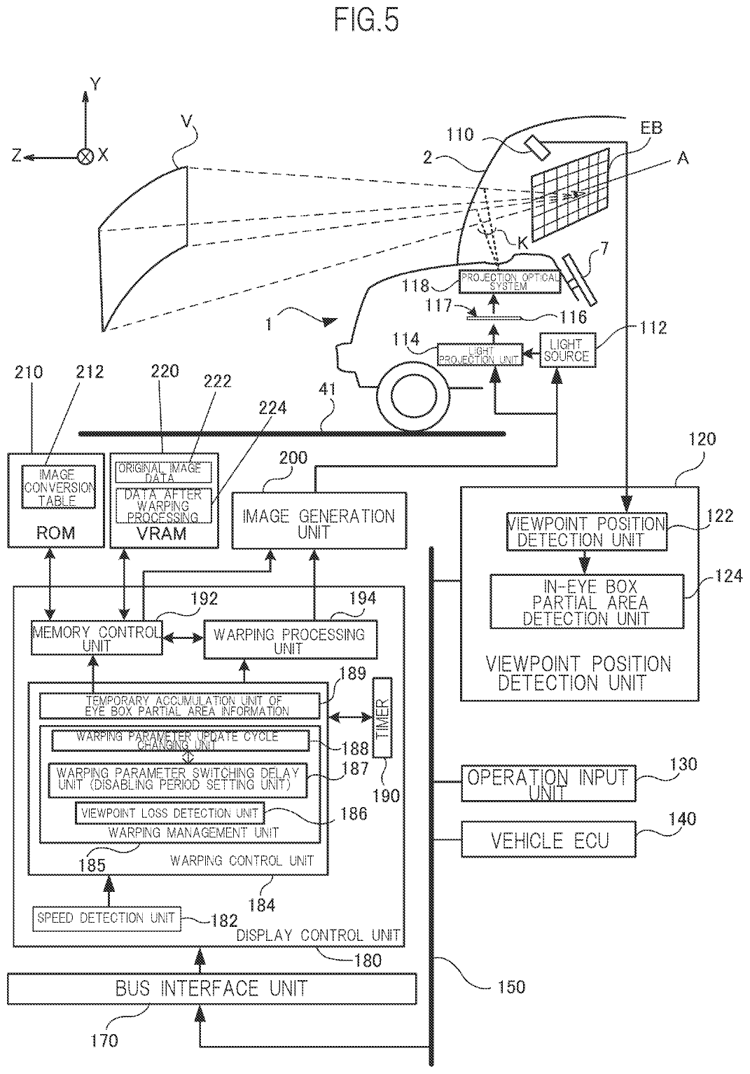

The description will be continued with reference to FIG. 5. FIG. 5 is a diagram illustrating an example of a system configuration of the HUD device. The vehicle 1 is equipped with a viewpoint detection camera 110 that detects the position of the driver's viewpoint A (eyes, pupils). Further, the vehicle 1 is equipped with an operation input unit 130 to allow the driver to set the necessary information for the HUD device 100, and further equipped with a vehicle ECU 140 that can collect various information of the vehicle 1.

Further, the HUD device 100 includes a light source 112, a light projection unit 114, the projection optical system 118, a viewpoint position detection unit (viewpoint position determination unit) 120, a bus 150, a bus interface 170, a display control unit 180, an image generation unit 200, the ROM 210 that incorporates the image conversion table 212, and a VRAM 220 that stores image (original image) data 222 and temporarily stores image data after warping processing 224. The display control unit (display control device) 180 is composed of one or a plurality of processors, one or a plurality of image processing circuits, one or a plurality of memories, and the like, and executes a program stored in the memories, thereby making it possible to control the HUD device 100 (display unit 116), for example, for generating and/or transmitting image data. The processor and/or image processing circuit may include at least one general-purpose microprocessor (e.g., a central processing unit (CPU)), at least one application-specific integrated circuits (ASIC), at least one field programmable gate array (FPGA), or any combination thereof. The memories include any type of magnetic media, such as hard disks, any type of optical media, such as CDs and DVDs, any type of volatile memory, such as semiconductor memory, and non-volatile memory. The volatile memory may include DRAM and SRAM, and the non-volatile memory may include ROM and NVRAM.

The viewpoint position detection unit 120 includes a viewpoint coordinate detection unit 122 and an in-eye box partial area detection unit 124 that detects (determines) which partial area of the eye box the viewpoint A is located in on the basis of detected viewpoint coordinates.

Further, the display control unit 180 includes a speed detection unit 182 that detects (determines) the speed of the vehicle 1 (which also serves as a low-speed state determination unit that determines a low-speed state), a warping control unit 184 (which includes a warping management unit 185), a timer 190, a memory control unit 192, and a warping processing unit (warping image correction processing unit) 194.

Further, the warping management unit 185 includes a viewpoint loss detection unit (or viewpoint lost detection unit) 186 that detects that a viewpoint loss (viewpoint lost) has occurred, and a warping parameter switching delay unit (disabling period setting unit) 187, a warping parameter update cycle changing unit 188, and a temporary accumulation unit of eye box partial area information 189, which temporarily stores the partial area information of the eye box corresponding to a detected viewpoint position.

Here, when the viewpoint position is first re-detected after the viewpoint lost, the warping parameter switching delay unit (disabling period setting unit) 187 performs a control not to immediately perform the switching of the warping parameter based on the re-detected viewpoint position at that timing, but to delay temporarily the switching of the warping parameter to thereby disable the switching of the warping parameter.

Further, the warping parameter update cycle changing unit 188 performs a control to change the update cycle of the warping parameter (specifically, lengthen the update cycle) at least in the disabling period, in parallel with the disabling period setting processing due to the delay in the switching timing of the warping parameter. By changing this update cycle, for example, it is possible to appropriately delay the timing of reflecting the updated warping parameter in the actual display.

The basic operation is as follows. That is, an operation is performed in which, with the use of the partial area information (information indicating which partial area of the eye box the viewpoint A is in) sent from the viewpoint position detection unit 120 as an address variable, the memory control unit 192 accesses the ROM 210 and reads the corresponding warping parameter, and with the use of the read warping parameter, the warping processing unit (warping image correction processing unit) 194 performs warping processing on the original image, the image generation unit 200 generates an image of a predetermined format on the basis of the data after the warping processing, and the image is supplied to, for example, the light source 112, light projection unit 114, or the like.

However, if warping simply follows the movement of the viewpoint A, as described above, when the viewpoint position is re-detected after the viewpoint lost, the appearance of the virtual image V may change instantaneously, causing visual discomfort to the driver. Therefore, a control to intentionally blunt (suppress) the sensitivity of the warping processing is performed. There are several modes of this control. The following is a step-by-step explanation.

The following description refers to FIG. 6. FIGS. 6(A) to 6(C) are timing charts illustrating an example of a control that provides a period during which the warping processing based on the re-detected viewpoint position is disabled. As illustrated in FIG. 6(A), during the period from time t10 to t11, the position of the viewpoint A is in the partial area Z(n, m) of the eye box EB (n and m are natural numbers that specify a partial area in the eye box), and a viewpoint loss (viewpoint lost) occurs at time t11 to t12, and then at time t12, it is re-detected that the viewpoint A is in the partial area Z(r, s) of the eye box EB (however, r and s are natural numbers that specify a partial area in the eye box, and the partial area specified here is different from Z(n, m).). The viewpoint loss period (viewpoint lost period) is denoted as T0.

Further, as illustrated in FIG. 6(C), the value of the update cycle of the warping parameter shall be fixed at RT1 and shall not be changed in this the present embodiment.

As illustrated by the solid line in FIG. 6(B), during the viewpoint lost period (time t11 to t12), the warping parameter is maintained at a parameter value of WP1 immediately before the occurrence of the viewpoint lost. As an alternative, as illustrated by the dashed line, it is possible to maintain the parameter value for the viewpoint lost period at a value corresponding to the center position of the eye box EB. However, in this case, if the driver is still looking at the virtual image during the viewpoint lost period, the change in the appearance of the virtual image due to the change in the parameter value may cause a sense of discomfort, and thus this alternative is not adopted.

Further, at time t12, the position of the viewpoint A is re-detected, but the switch to the parameter corresponding to the re-detected position is not performed immediately, and the parameter value WP1 is maintained for a predetermined period from the re-detection time t12 (here, the period up to time t13), and at the time t13, the parameter value is changed to a value WP2 based on the re-detected position. The period from time t12 to t13 is a disabling period Ta. When the viewpoint position is re-detected at least once during this disabling period Ta, the parameter change (application of the parameter) based on the re-detected position is disabled and warping using the maintained original parameter is performed.

Provision of the disabling period will cause the parameter to be fixed for a short while, and no instantaneous switching of the warping parameter will be made. Further, in that disabling period, even if the viewpoint position is unstable and moves, for example, through multiple partial areas of the eye box, the parameter is not changed on the basis of continuous re-detection of the viewpoint position. This stabilizes the warping processing. Therefore, for example, when the driver's viewpoint A goes out of the eye box and then back into the eye box, it is suppressed that the appearance of the virtual image V instantaneously changes and a sense of discomfort occurs.

The description will be continued with reference to FIG. 7. FIGS. 7(A) to 7(D) are timing charts illustrating an other example of a control that provides a period during which the warping processing based on the re-detected viewpoint position is disabled (in a case where parameter update cycle change processing is used together, etc.).

As illustrated in FIG. 7(A), a viewpoint loss (viewpoint lost) occurs from time t1 to t3. The viewpoint loss period (viewpoint lost period) is denoted as T1. Further, as illustrated in FIG. 7(A), the viewpoint lost period T1 is greater than or equal to a predetermined threshold value (threshold value for determining the length of the viewpoint lost period) Th when compared to the threshold value Th. In other words, in the example of FIG. 7, Th≤T1 is valid (however, FIG. 7(A) illustrates the case of Th<T1 as a specific example).

Further, as illustrated in FIG. 7(B), time t3 to t4 is the disabling period Ta. The warping parameter WP1 may switch to WP2 instantaneously (at time t4), or may switch gradually over time, as illustrated by dashed characteristic lines Tk1 or Tk2. Tk1 and Tk2 correspond to characteristic lines G1 and G2 in FIG. 7(D) (described below). When the switching of parameters such as the characteristic lines Tk1 and Tk2 is performed, the time at which the switching to WP2 is completed for the parameter value is time t5 which is a time further delayed by a time (period) Tb from the time t4 (this point will also be described below).

Further, the example of FIG. 7 also refers to the warping parameter update cycle change processing. FIG. 7(C) illustrates a case where the update cycle of the warping parameter is fixed at RT1 and no change is made in the update cycle. FIG. 7(D) illustrates that during the disabling period Ta from time t3 to t4, the warping parameter update cycle change processing to change the update cycle of the warping parameter from RT1 to RT2 (specifically, lengthen the update cycle) is performed (used together).

For example, if the frame rate of the image (virtual image) is 60 fps (frames per second), then image processing (image display processing) is performed at 60 frames per second (in other words, one frame period is 1/60 second). As an example, assume that it is normal to also update the warping parameter every frame.

Here, in the disabling period Ta after the viewpoint lost, if the parameter is updated every 2 frames, the update cycle becomes 2/60 seconds, and if it is performed every 3 frames, the update cycle is 3/60 seconds, and the update cycle becomes longer. In this way, it is possible to lengthen (increase) the update cycle by switching to the update based on multiple frames. As the update cycle becomes longer, the reflection of the updated warping parameter in the image (virtual image) becomes slower. In other words, the sensitivity of reflecting the updated parameter in the display is slowed down. After the disabling period, the update cycle of the changed parameter will be restored (from RT2 to RT1). However, in reality, restoration of the update cycle is not instantaneous, but requires a certain amount of time, which means that even if the warping parameter is switched, the reflection of the switched parameter in the actual display will be delayed.

This makes it easier to provide an appropriate delay of some time width (a delay that is long enough for the driver to perceive that the change in the appearance in the actual display has been delayed (in other words, a delay that effectively has the effect of slightly extending the width of the disabling period)). An effect such as facilitating the design of a timing control circuit can be expected.

Further, the degree of increase in the update cycle of the parameter can be controlled in a variable manner, or the timing of restoring the increased update cycle to its original cycle can be devised, thereby expanding the range of control variations and enabling flexible responses. The amount of delay in the actual display control can also be easily set quite widely.

A variation of the timing for restoring the increased update cycle is illustrated in FIG. 7(D). In FIG. 7(D), as illustrated by the dashed (bold) characteristic line G1, the time at which the update cycle is restored may be changed from time t4 to time t5. In this case, the period when the sensitivity of the reflection of the parameter in the display is slowed down is extended. In this case, in addition to delaying the switching of the parameter to provide the disabling period, by delaying the timing of restoring the update cycle (restoring from RT2 to RT1) and delaying the reflection of the updated parameter in the actual display, it becomes easier to create a required delay, and the burden on the timing circuit and the like is reduced.

Further, in FIG. 7(D), as illustrated by the dashed (thin) characteristic line G2, the processing of restoring the update cycle to its original cycle starts at time t4, but the processing may be performed in such a manner that the update cycle is gradually restored with a time allowance. For example, a control is performed in which when the parameter update cycle is restored from 1/15 second (=RT2) to 1/60 second (=RT1), the cycle is not restored immediately, but is gradually switched to 1/30 second, 1/45 second, and 1/60 in a predetermined time as a unit. By controlling the gradual switching of the update cycle on the time axis, the delay in reflecting the changed parameter in the display can be managed with greater precision.

The description will be continued with reference to FIG. 8. FIGS. 8(A) and 8(B) are timing charts illustrating an other example of a control that provides a period during which the warping processing based on the re-detected viewpoint position is disabled (first control example in a case where a viewpoint lost period is shorter than a threshold value).

In the example of FIG. 8, the control unit (reference numeral 184 or 185 in FIG. 5) clocks a viewpoint loss time (viewpoint lost time: sometimes simply referred to as lost time) when a viewpoint is lost, with the use of, for example, the timer 190, and if the viewpoint lost time is shorter than the predetermined threshold value Th, the control unit performs a control to lengthen a period to disable (disabling period) as compared to a case where the viewpoint lost time is longer than the threshold value Th (e.g., the example of FIG. 7).

In FIG. 8, the viewpoint lost time T10 (time t1 to t6) is less than the threshold value Th. The viewpoint lost occurs at time t1, and the position of viewpoint A is re-detected at time t6. In the previous example of FIG. 7, there was the disabling period Ta after the re-detection, but in the example of FIG. 8, the disabling period is extended for another period Td. The disabling period is a period of Te (=Ta+Td).

By setting a longer period during which the warping parameter is fixed without changing and the visual quality of the image (virtual image) is maintained at a constant level, the driver can be made aware that the re-detection after the viewpoint lost has been successful and that the corresponding processing is now being performed. In other words, by extending the period during which the warping parameter is fixed and performing image processing using the warping parameter updated over time, even when the appearance of the image (virtual image) changes, the driver is made aware that the change does not occur suddenly with the movement of the driver's eyes and is a change with a margin in time.

This makes it easier for the driver to sense that, although the viewpoint position was lost due to the movement of one's own eyes, the system of the HUD device succeeded in re-detecting the viewpoint position, and the processing corresponding to the viewpoint lost has been performed.

In other words, the HUD device (system side) can present the driver who is the user that the processing after the viewpoint lost is being done properly. This gives the driver a sense of security and mental stability, and thus it is possible to obtain the effect of making a sense of discomfort less likely to occur or reducing a sense of discomfort.

The description will be continued with reference to FIG. 9. FIGS. 9(A) and 9(B) are timing charts illustrating an other example of a control that provides a period during which the warping processing based on the re-detected viewpoint position is disabled (second control example in a case where a viewpoint lost period is shorter than a threshold value).

In the example of FIG. 9, the control unit (reference numeral 184 or 185 in FIG. 5) clocks a viewpoint loss time (viewpoint lost time: sometimes simply referred to as lost time) when a viewpoint is lost with the use of, for example, the timer 190, and if the viewpoint lost time is shorter than the predetermined threshold value Th, the control unit performs a control to shorten a period to disable (disabling period) as compared to a case where the viewpoint lost time is longer than the threshold value Th (e.g., the example of FIG. 7). The direction of control in FIG. 9 is opposite to that in FIG. 8. However, because of a different effect that can be obtained, each of the examples in FIGS. 8 and 9 can be applied selectively depending on an expected effect.

When the viewpoint lost time is short, the change in the viewpoint position is considered to be small (the viewpoint movement distance is considered to be relatively short). Therefore, in the example of FIG. 9, the time to disable the warping processing using a new warping parameter is set to be shorter than the time when the viewpoint lost time is longer than the threshold value Th (example of FIG. 7). As illustrated in FIG. 9(B), the warping parameter is switched from WP1 to WP2 at time t9. A period Tf from time t6 to t9 is the disabling period. The disabling period Tf in FIG. 9 is set to be shorter than the disabling period Ta in FIG. 7.

This allows, for example, after performing the minimum necessary disabling (timing delay), to reduce a sense of discomfort or suppress the occurrence of a sense of discomfort by quickly displaying an appropriate warping-corrected image (virtual image) corresponding to the viewpoint position.

In other words, when the viewpoint lost period is short, the movement distance of the viewpoint position is presumed to be small, and it can be assumed that there is little difference in the distortion of the virtual image before and after the updating of the warping parameter. Considering this point, a sudden change in the appearance of the virtual image immediately after the re-detection of the viewpoint position (in other words, in a fairly short time) is prevented, and then the normal viewpoint follow-up warping control is restored, thereby surely obtaining the effect of improving visibility.

The description will be continued with reference to FIG. 10. FIG. 10 is a diagram illustrating an example of a characteristic in a case where the period during which the warping processing based on the re-detected viewpoint position is disabled is controlled in a variable manner in accordance with a vehicle speed. In the example of FIG. 10, the disabling period after a viewpoint lost is controlled adaptively in accordance with the vehicle speed of the vehicle 1.

The speed detection unit 182 of FIG. 5 described above also functions as a low-speed state determination unit. When the low-speed information determination unit 182 determines that the vehicle 1 is in a low-speed state (stopped state or traveling state at a low speed) (for example, determines with the use of a threshold value for determining a vehicle speed), the control unit (184, 185) performs a control to lengthen a period during which the warping processing using a new parameter is disabled (disabling period), as compared to a disabling period in a state where the vehicle 1 is in a state faster than the low-speed state.

In FIG. 10, when the vehicle speed is in the low-speed state of 0 to U1, the values of the disabling periods Ta Te, and Tf (corresponding to FIG. 7(B), FIG. 8, and FIG. 9, respectively) are N1, and in the medium-speed state of U1 to U2, their values are smaller than N1. The same is true for the high-speed state where the vehicle speed is U2 or higher.

In the low-speed state, the driver (user) is sensitive to visual fluctuations in the front and the like and can easily detect these fluctuations. Therefore, at this time, a measure is taken in such a manner that the reflection of the new parameter in the image after the viewpoint lost is delayed to a greater extent, and a sense of discomfort caused by the instantaneous change in display appearance is less likely to occur. As the vehicle speed increases out of the low-speed state, the disabling periods Ta, Te, and Tf are reduced (in doing so, it is possible to include a case where the disabling period is eliminated), and a control is performed with an emphasis on accelerating the distortion correction of the image based on the viewpoint position re-detected after the lost. This allows for a more flexible and appropriate warping control in response to a vehicle speed.

Further, in the control example in FIG. 10, the control unit (reference numeral 184 or 185 in FIG. 5) changes a period during which the warping processing is disabled (disabling period) in accordance with a vehicle speed of the vehicle 1, and in this case, when a speed of the vehicle 1 is within a range of equal to or higher than a first speed value U1 (U1>0) and equal to or lower than a second speed value U2 that is higher than the first speed value, the control unit performs a control to reduce the period during which the warping processing is disabled (disabling period) with respect to the vehicle speed as the vehicle speed becomes fast (the control is illustrated by characteristic lines Q2, Q3, and Q4, and this is the first control). Further, in doing so, the control is not performed in the range where the vehicle speed is below the first speed U1 and above the second speed U2, and the value of the disabling period is fixed at N1 or N2. Consequently, it is possible to avoid imposing an excessive burden on the system of the HUD device.

Further, in a case where a control illustrated by a characteristic line Q3 is performed, a control to moderate a degree of reduction in the disabling period when the vehicle speed is in a range close to the first speed value U1 and to make the degree of reduction steeper as the vehicle speed becomes away from the first speed value U1 is performed.

In other words, when the vehicle is in a low-speed state where the driver can easily perceive visual changes in the image (virtual image) (in other words, the vehicle speed is in a range close to the first speed value U1), a control to moderate a degree of reduction in the disabling period in such a manner that a sudden warping parameter update is suppressed is performed (this is the second control). In this case, a more precise control can be achieved.

Further, in a case where a control illustrated by a characteristic line Q4 is performed, a control to moderate a degree of reduction in the disabling period when the vehicle speed is in a range close to the first speed value U1, to make the degree of reduction further steeper as the vehicle speed becomes away from the first speed value, and to moderate the degree of reduction as the vehicle speed approaches the second speed value U2 is performed (the control of an inverted S-shaped characteristic, and this is the third control). In this third control, in addition to the second control described above, a control to moderate the degree of reduction in the disabling period as the vehicle speed approaches the second speed value U2 is further performed, and when the vehicle speed reaches the second speed value U2, the reduction is stopped and the disabling period becomes constant, thereby suppressing that the change suddenly (unexpectedly) peaks out and a sense of discomfort occurs. This can further improve the visibility of a virtual image.

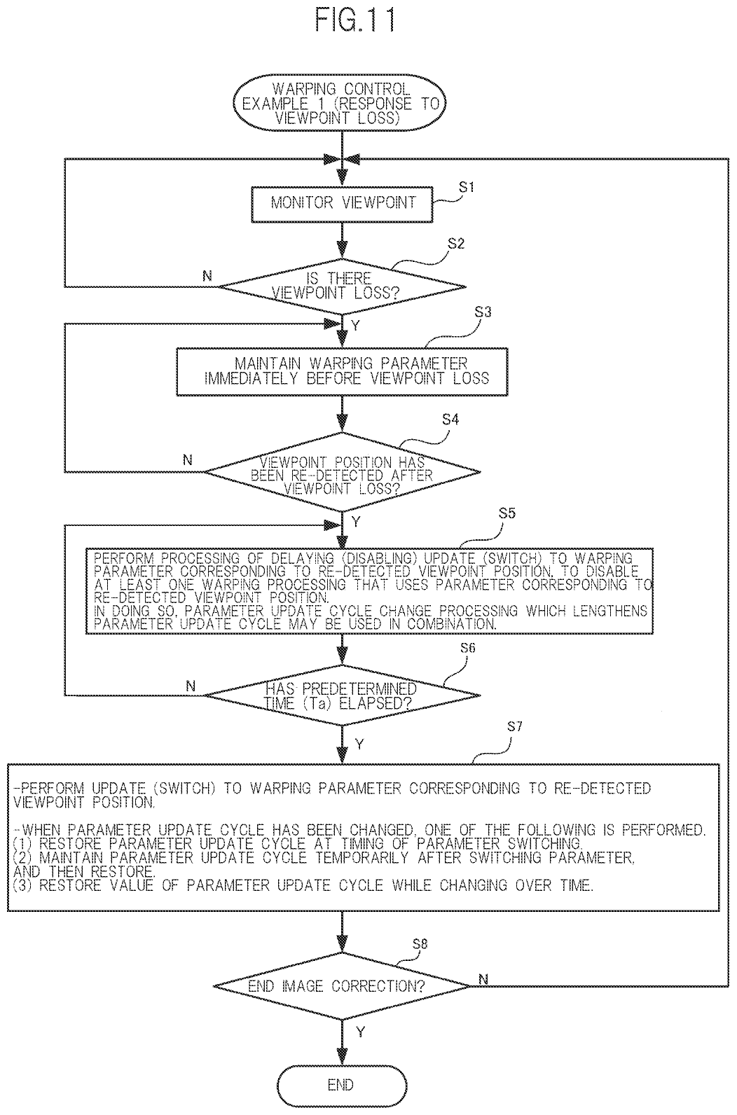

The description will be continued with reference to FIG. 11. FIG. 11 is a flowchart illustrating an example of a procedure for a warping image correction control corresponding to a viewpoint lost (first control example: corresponding to FIGS. 6 and 7). A viewpoint position is monitored (step S1) and it is determined that if there is a viewpoint loss (viewpoint lost) (step S2).

If N in step S2, the processing returns to step S1. If Y, the warping parameter immediately before the viewpoint loss is maintained (step S3). Subsequently, it is determined whether the viewpoint position has been re-detected after the viewpoint loss (step S4). If N, the processing returns to step S3. If Y, the processing proceeds to step S5.

In step S5, the processing of delaying (disabling) the update (switch) to the warping parameter corresponding to the re-detected viewpoint position is performed, thereby disabling at least one warping processing that uses the parameter corresponding to the re-detected viewpoint position. In doing so, the parameter update cycle change processing (the processing in FIG. 7(D)), which lengthens the parameter update cycle, may be used in combination.

In step S6, it is determined whether the predetermined time (disabling period) Ta has elapsed. If N, the processing returns to step S5. If Y, the processing proceeds to step S7.

In step S7, update (switch) to the warping parameter corresponding to the re-detected viewpoint position is performed. In principle, the disabling period ends at this time (however, when the control of characteristic lines Tk1 and Tk2 of FIG. 7(B) are performed, the control unit can be designed in such a manner that the actual disabling period is extended until the timing when the parameter is completely switched). Here, if the parameter update cycle has not been changed in step S5, the processing in step S7 ends, and the processing proceeds to step S8.

Further, if the parameter update cycle has been changed in step S5, in step S7, the processing of restoring the parameter update cycle is also performed. There are three possible methods illustrated in FIG. 7(B) (any of (1) to (3) below) for restoring.
(1) Restore the parameter update cycle at the timing of parameter switching (in other words, synchronized with the switching of the parameter) (the processing illustrated by the solid line in FIG. 7(B)).
(2) Temporarily maintain the parameter update cycle after the switching of the parameter, and then restore (processing according to the characteristic line Tk1 in FIG. 7(B)).
(3) Restore the value of the parameter update cycle by changing it over time (processing according to the characteristic line Tk2 in FIG. 7(B)).

Subsequently, in step S8, it is determined whether to end image correction. If Y, the processing ends. If N, the processing returns to step S1.

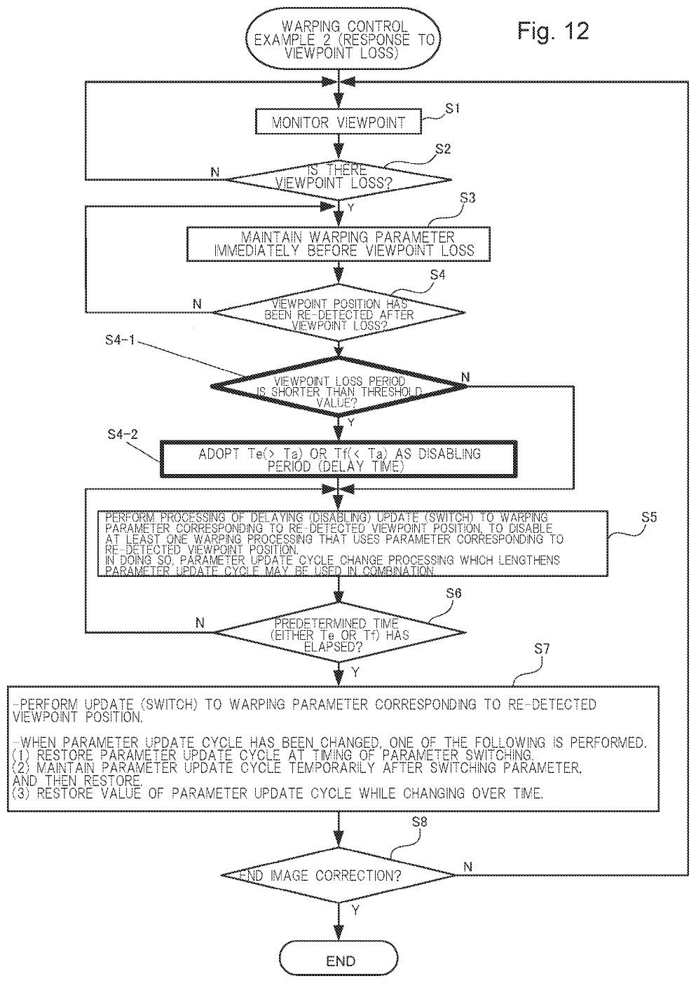

The description will be continued with reference to FIG. 12. FIG. 12 is a flowchart illustrating an example of a procedure for a warping image correction control corresponding to a viewpoint lost (third control example: corresponding to FIGS. 8 and 9). In FIG. 12, steps S4-1 and S4-2 illustrated by bold lines in the figure are added to the procedure in FIG. 11. Since the rest of the processing is the same as in FIG. 11, the explanation of common processing is omitted.

In step S4-1, it is determined whether the viewpoint loss period (viewpoint lost period) is shorter than a threshold value. If N, the processing proceeds to step S5.

If Y, in step S4-2, Te (>Ta) is adopted as the disabling period (delay time for switching a parameter) (in the case of FIG. 8), or Tf (<Ta) is adopted (in the case of FIG. 9). In step S6, it is determined whether the time corresponding to either Te or Tf has elapsed.

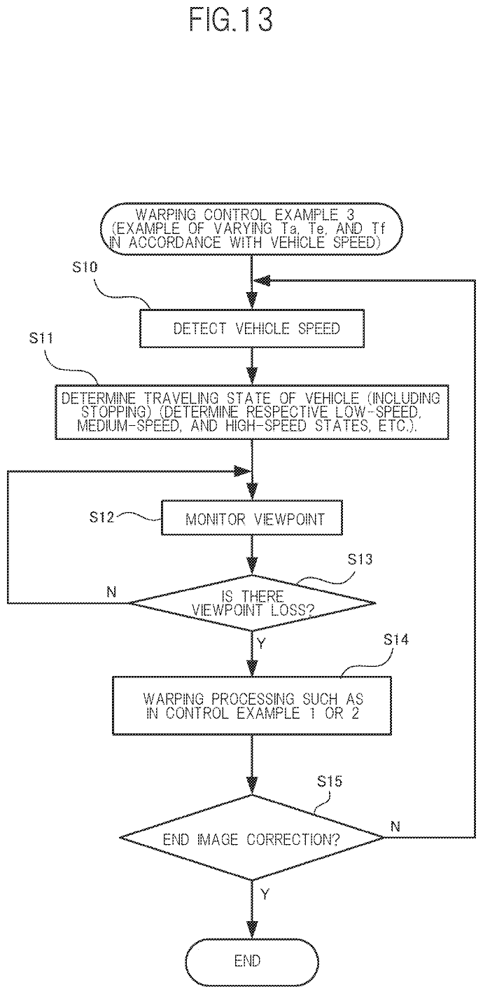

The description will be continued with reference to FIG. 13. FIG. 13 is a flowchart illustrating an example of a procedure for a warping image correction control corresponding to a viewpoint lost (third control example: corresponding to FIG. 10).

In step S10, the vehicle speed is detected. In step S11, the traveling state of the vehicle (including stopping) is determined. For example, the determination of respective low-speed, medium-speed, and high-speed states may be performed.

In step S12, a viewpoint is monitored, and in step S13, it is determined that if there is a viewpoint loss (viewpoint lost). If N, the processing returns to step S12. If Y, the processing proceeds to step S14.

In step S14, the warping processing such as the control example 1 in FIG. 11 or the control example 2 in FIG. 12 described above is performed. Subsequently, in step S15, it is determined whether to end image correction. If Y, the processing ends. If N, the processing returns to step S10.

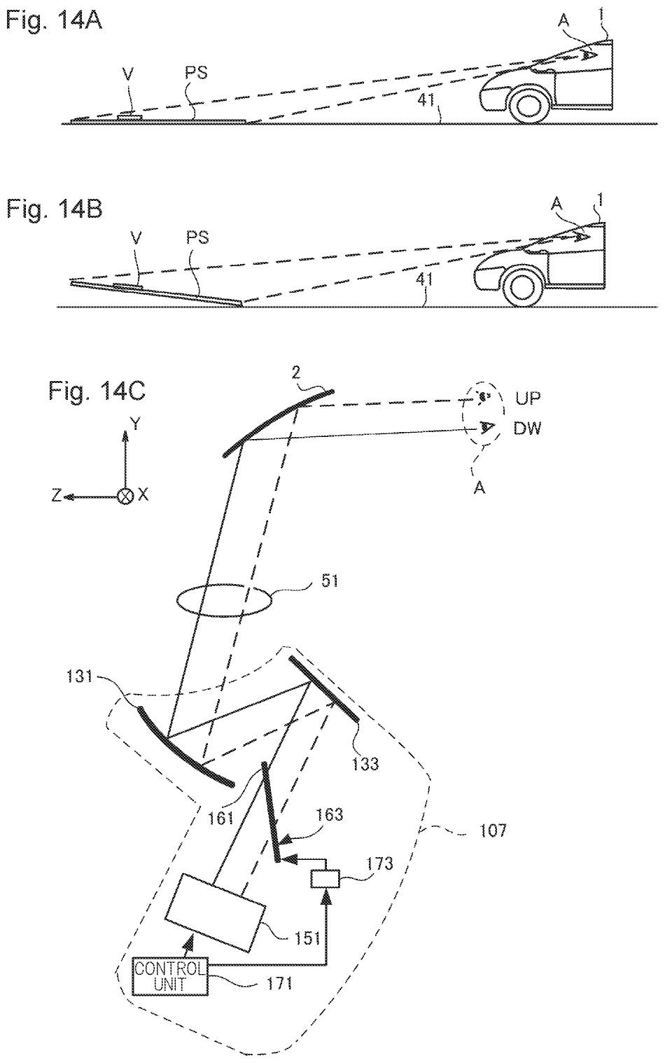

The description will be continued with reference to FIG. 14. FIG. 14(A) is a diagram illustrating a display example by a road surface superimposition HUD. FIG. 14(B) is a diagram illustrating a display example by an inclined surface HUD. FIG. 14(C) is a diagram illustrating a configuration example of a main part of a HUD device.

FIG. 14(A) illustrates an example of virtual image display by a road surface superimposition HUD in which the hypothetical virtual image display surface PS corresponding to the image display surface (reference numeral 117 in FIG. 5 or reference numeral 163 in FIG. 14(C)) of the display unit (reference numeral 116 in FIG. 5 or reference numeral 161 in FIG. 14(C)) is arranged so as to be superimposed on a road surface 41 in front of the vehicle 1.

FIG. 14(B) illustrates an example of virtual image display by the inclined surface HUD in which the virtual image display surface PS is arranged at an angle with respect to the road surface 41 in such a manner that a distance between a near end portion that is an end portion of the virtual image display surface PS on a side closer to the vehicle 1 and the road surface 41 is small, and a distance between a far end portion that is an end portion of the virtual image display surface PS on a side further from the vehicle 1 and the road surface 41 is large.

These can perform various displays with the use of the wide virtual image display surface PS superimposed on the road surface 41 or the wide virtual image display surface PS provided at an angle with respect to the road surface 41, in the range of, for example, 5 m to 100 m in front of the vehicle 1. It is preferable that the HUD device is increased in size and the eye box EB is also increased in size to detect the viewpoint position with high accuracy in a wider range than before and perform image correction using an appropriate warping parameter. However, if the viewpoint lost occurs, the highly accurate control of switching the warping parameter may in fact reduce the visibility of the image (virtual image) after the viewpoint is re-detected. Therefore, the application of the control method of the present invention becomes effective.

The description will be continued with reference to FIG. 14(C). The HUD device 107 of FIG. 14(C) includes a control unit 171, a light projection unit 151, a screen 161 as a display unit having an image display surface 163, a reflecting mirror 133, a curved mirror (concave mirror, etc.) 131 in which the reflection surface is designed as a free curved surface, and an actuator 173 that drives the display unit 161.

In the example of FIG. 14(C), when adjusting the position of the eye box EB in accordance with the height position of the driver's viewpoint A, the HUD device 107 does not move the curved mirror 131 which is an optical member that projects the display light onto the windshield 2 (the actuator for the curved mirror 131 is not provided), and changes the reflection position of display light 51 of the image in the optical member 131.

In other words, when the height position of the eye box EB is adjusted in accordance with the height position of the driver's eyes (viewpoint A), the optical member 131 which projects light onto the projected member 2 is not rotated by, for example, using an actuator, but the reflection position of the light in the optical member 131 is changed. The height direction is the Y direction in the figure (the direction along the vertical line of the road surface 41, and the direction away from the road surface 41 is the positive direction). The X direction is the right-left direction of the vehicle 1, and the Z direction is the front-rear direction (or forward direction) of the vehicle 1.

In recent years, HUD devices tend to be developed on the premise of displaying a virtual image over a fairly wide area in front of a vehicle, for example, and this inevitably makes the device larger. As a matter of course, the optical member 131 will also become larger. If this optical member 131 is rotated with the use of an actuator or the like, the precision of controlling the height position of the eye box EB may be degraded due to the error. To prevent this, the position at which a light ray is reflected by the reflection surface of the optical member 131 is changed.

In such a large optical member 131, the distortion of the virtual image is prevented as much as possible by optimally designing the reflection surface as a free curved surface. However, as mentioned above, distortions may inevitably become apparent when, for example, the driver's viewpoint A is located in the periphery of the eye box EB.

Therefore, in such a case, the above control to temporarily disable (delay) the application of the parameter corresponding to the viewpoint position after the re-detection within a predetermined range is performed, whereby it is possible to make a sense of discomfort due to a change in appearance caused by distortion of the virtual image less likely to occur, and to effectively utilize the above control to improve the visibility of the virtual image.

As described above, according to the present invention, when performing the viewpoint position follow-up warping control that updates the warping parameter in accordance with the driver's viewpoint position, it is possible to effectively suppress that the appearance of the image changes instantaneously with the update of the warping parameter after the viewpoint loss (viewpoint lost) occurs, which causes a sense of discomfort to the driver.

The present invention can be used in either a monocular HUD device in which the display light of the same image is incident on each of the right and left eyes, or a parallax HUD device in which an image having parallax is incident on each of the right and left eyes.

In this specification, the term vehicle can also be interpreted, in a broad sense, as a conveyance. Further, terms related to navigation (e.g., signs, etc.) shall be interpreted in a broad sense, taking into account, for example, the perspective of navigation information in a broad sense that is useful for vehicle operation. Further, the HUD device shall also include those used as simulators (e.g., aircraft simulators).

The present invention is not limited to the exemplary embodiments described above, and a person skilled in the art may easily modify the exemplary embodiments described above to the scope of the claims.

### DESCRIPTION OF REFERENCE NUMERALS

1 vehicle (own vehicle)

2 projected member (reflective transmissive member, windshield, etc.)

4 projection area

5 virtual image display area

7 steering wheel

51 display light

100 HUD device

110 viewpoint detection camera 110

112 light source

114 light projection unit

116 display unit

117 display surface (image display surface)

118 projection optical system

120 viewpoint position detection unit (viewpoint position determination unit)

122 viewpoint coordinate detection unit

124 in-eye box partial area detection unit

130 operation unit

131 curved mirror (concave mirror, etc.)

133 reflecting mirror (including reflective mirror, corrective mirror, etc.)

140 vehicle ECU

150 bus

151 light source unit

161 display unit (screen, etc.)

63 display surface (image display surface)

170 bus interface

171 control unit

173 actuator that drives the display unit

180 display control unit (display control device)

182 speed detection unit

184 warping control unit

185 warping management unit

186 viewpoint loss (viewpoint lost) detection unit

187 warping parameter switching delay unit (disabling period setting unit)

188 warping parameter update cycle changing unit

189 temporary accumulation unit of eye box partial area information

192 memory control unit

194 warping processing unit

200 image generation unit

210 ROM

220 VRAM

212 image conversion table

222 image (original image) data

224 image data after warping processing

EB eye box

Z (Z1 to Z9, etc.) partial area of eye box

WP warping parameter

PS virtual image display surface

V virtual image

1. A display control device that controls a head-up display (HUD) device mounted on a vehicle and projecting an image onto a projected member provided in the vehicle to thereby make a driver to visually recognize a virtual image of the image, the display control device comprising a control unit that performs a viewpoint position follow-up warping control to update a warping parameter in accordance with a viewpoint position of the driver in an eye box and to pre-distort an image to be displayed on the display unit with use of the warping parameter in such a manner that the image has a characteristic opposite to a distortion characteristic of the virtual image of the image,
wherein when a viewpoint lost in which a position of at least one of right and left viewpoints of the driver is unclear is detected, the control unit maintains, in a viewpoint lost period, the warping parameter set immediately before the viewpoint lost period, and when a position of the viewpoint is re-detected after the viewpoint lost period, the control unit disables at least one warping processing that uses the warping parameter corresponding to the re-detected viewpoint position.

2. The display control device according to claim 1, wherein the control unit compares the viewpoint lost time with a threshold value, and if the viewpoint lost time is shorter than the threshold value, the control unit performs a control to lengthen a period during which the warping processing is disabled as compared to a case where the viewpoint lost time is longer than the threshold value.

3. The display control device according to claim 1, wherein the control unit compares the viewpoint lost time with a threshold value, and if the viewpoint lost time is shorter than the threshold value, the control unit performs a control to shorten a period during which the warping processing is disabled as compared to a case where the viewpoint lost time is longer than the threshold value.

4. The display control device according to claim 1, wherein when an update cycle of the warping parameter before the viewpoint lost occurs and during the viewpoint lost period is defined as a first update cycle RT1 and an update cycle of the warping parameter during a period during which the warping processing is disabled is defined as a second update cycle RT2, the control unit changes a parameter update cycle in such a manner that RT1<RT2.

5. The display control device according to claim 4, wherein after changing the parameter update cycle from the RT1 to the RT2, at an end timing of a period during which the warping processing is disabled, the control unit restores the parameter update cycle from the RT2 to the RT1, or at a timing when a predetermined time has further elapsed from the end timing of the period during which the warping processing is disabled, the control unit restores the parameter update cycle from the RT2 to the RT1, or the control unit starts changing the parameter update cycle starting from the end timing of the period during which the warping processing is disabled, and gradually restores the parameter update cycle from the RT2 to the RT1 with a lapse of time.

6. The display control device according to claim 1, further comprising a low-speed state determination unit that determines whether a speed of the vehicle is in a low-speed state, wherein the control unit lengthens a period during which the warping processing is disabled when the vehicle is in the low-speed state including a stopped state, as compared to a period during which the warping processing is disabled in a state where the vehicle is in a state faster than the low-speed state.

7. The display control device according to claim 1, wherein the control unit changes a period during which the warping processing is disabled in accordance with a vehicle speed of the vehicle, and in this case, when a speed of the vehicle is within a range of equal to or higher than a first speed value U1 (U1>0) and equal to or lower than a second speed value U2 that is higher than the first speed value, the control unit performs a control to reduce the period during which the warping processing is disabled with respect to the vehicle speed as the vehicle speed becomes fast, or performs a control to moderate a degree of the reduction when the vehicle speed is in a range close to the first speed value and to make the degree of the reduction steeper as the vehicle speed becomes away from the first speed value, or performs a control to moderate the degree of the reduction when the vehicle speed is in a range close to the first speed value, to make the degree of the reduction further steeper as the vehicle speed becomes away from the first speed value, and to moderate the degree of the reduction as the vehicle speed approaches the second speed value.

8. The display control device according to claim 1, wherein when adjusting a position of the eye box in accordance with a height position of the viewpoint of the driver, the head-up display device does not move the optical member and changes a reflection position of display light of the image in the optical member.

9. The display control device according to claim 1, wherein a hypothetical virtual image display surface corresponding to an image display surface of the display unit is arranged so as to be superimposed on a road surface in front of the vehicle, or is arranged at an angle with respect to the road surface in such a manner that a distance between a near end portion that is an end portion of the virtual image display surface on a side closer to the vehicle and the road surface is small, and a distance between a far end portion that is an end portion of the virtual image display surface on a side further from the vehicle and the road surface is large.

10. A head-up display device comprising:
the play control device according to claim 1;
a display unit that displays an image; and
an optical system including an optical member that reflects and
projects display light of the image onto the projected member.
